(19) United States
(12) Patent Application Publication
(10) Pub. No.: US 2006/0136657 A1
(43) Pub. Date: Jun. 22, 2006

(54) Embedding a filesystem into a non-volatile device

(75) Inventors: John C. Rudelic, Folsom, CA (US); Lance Dover, Fair Oaks, CA (US)

Correspondence Address: INTEL CORPORATION, P.O. BOX 5326, SANTA CLARA, CA, 95056-5326, US

(73) Assignee: INTEL CORPORATION

(21) Appl. No.: 11/021,528

(22) Filed: Dec. 22, 2004

(51) Int. Cl. G06F 12/00

(52) U.S. Cl. 711/103

(57) ABSTRACT

An integrated microcontroller is embedded with non-volatile memory to enhance host processor execution by transferring the computational load of the filesystem from the host processor to the integrated microcontroller. The integrated microcontroller allows the physical nature of the non-volatile memory to be changed without changing the host software.

Flash memory circuits may include a controller to support a sectored interface. The controller resident in present day flash memory is limited in capability, primarily controlling the program and erase algorithms. Additional capabilities in a non-volatile memory device are needed.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

The sole FIGURE illustrates a wireless system that incorporates a flexible and simplified scheme used to interface the host processor with the system memory.

It will be appreciated that for simplicity and clarity of illustration, elements illustrated in the FIGURES have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other while “coupled” may further mean that two or more elements are not in direct contact with each other, but yet still co-operate or interact with each other.

The sole FIGURE illustrates features of the present invention that may be incorporated in a device 10. Device 10 may have applications in laptops, MP3 players, cameras, medical or biotech equipment, automotive safety and protective equipment, and automotive infotainment products. Additional applications, some including wireless devices operating in networks such as mobile phones, communicators and Personal Digital Assistants (PDAs) may incorporate the present invention. However, it should be understood that the scope of the present invention is not limited to these examples.

As an example of device 10 operating in a wireless communications embodiment, a transceiver 12 both receives and transmits a modulated signal from one or more antennas. The analog front end transceiver may be a stand-alone Radio Frequency (RF) integrated analog circuit, or alternatively, be embedded with a host processor 14 as a mixed-mode integrated circuit. The received modulated signal may be frequency down-converted, filtered, then converted to a baseband, digital signal.

Host processor 14 may include baseband and applications processing functions that utilize one or more processor cores. Cores 16 and 18, in general, fetch instructions, generate decodes, find operands, and perform appropriate actions, then store results. The use of multiple cores may allow one core to be dedicated to handle application specific functions such as, for example, graphics, modem functions, etc. Alternatively, the multiple cores may allow processing workloads to be shared across the cores. A host controller 20 includes a hardware/software interface between the host controller software driver and the host controller hardware that interfaces with a system memory 24.

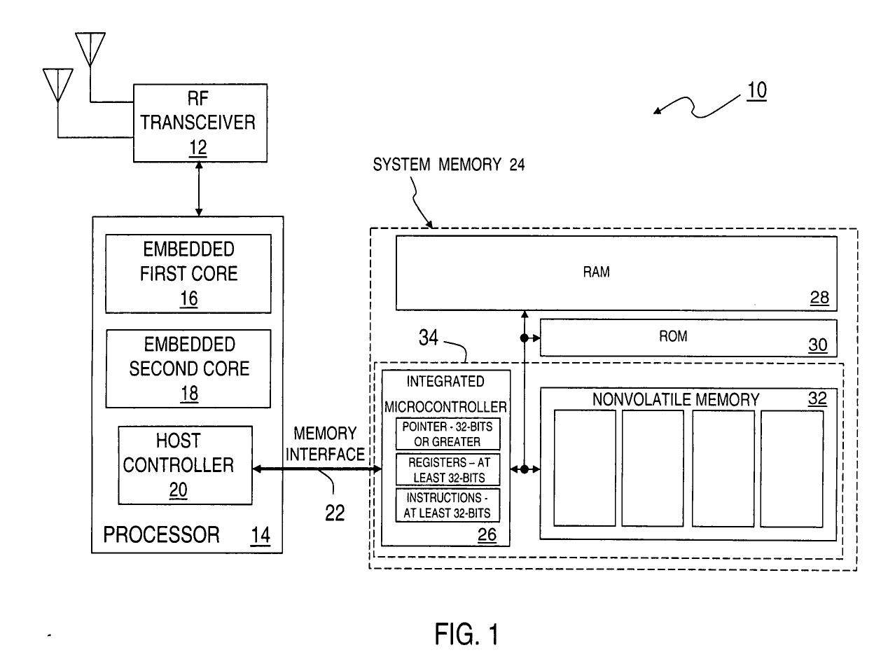

In the approach illustrated in the embodiment shown in FIG. 1, chipsets and processors may be interconnected through a memory interface 22 to an integrated microcontroller 26 and a system memory 24 that is capable of integrating an entire filesystem. System memory 24 may include a combination of memories such as a disk (not shown), a Random Access Memory (RAM) 28, a Read Only Memory (ROM) 30 and a non-volatile memory 32, although the type and variety of memories included in system memory 24 are not a limitation of the present invention.

Non-volatile memory 32 may provide non-volatile file and data storage and include, for example, a Flash memory, an Electrically Programmable Read-Only Memory (EPROM), an Electrically Erasable and Programmable Read Only Memory (EEPROM), a Ferroelectric Random Access Memory (FRAM), a Polymer Ferroelectric Random Access Memory (PFRAM), a Magnetic Random Access Memory (MRAM), an Ovonics Unified Memory (OUM) or any other device capable of storing instructions and/or data. However, it should be understood that the scope of the present invention is not limited to these examples. Further, in the embodiment where non-volatile memory 32 is a Flash memory, the memory cells may store data either as single-level or Multi-Level Cells (MLC).

Note that system memory 24 may be configured in a variety of ways. In one embodiment, integrated microcontroller 26 may be packaged separate from any of the memory devices. In another embodiment, a multi-chip package may include integrated microcontroller 26 interconnected with one or more of RAM 28, ROM 30 and non-volatile memory 32. In yet another embodiment, integrated microcontroller 26 may be embedded with one of the memory devices such as, for example, the non-volatile memory 32. In this embodiment, the non-volatile memory 32 may be a flash memory device that includes embedded integrated microcontroller 26. Note that integrated microcontroller 26 is not the microcontroller residing in present day flash memory devices that controls basic program and erase functions. Instead, the present invention integrates or combines a full featured integrated microcontroller 26 with non-volatile memory 32, and thereby, includes basic program and erase functions along with additional capabilities in system memory 24.

In general, memory controllers having either 8 bit and/or 16 bit registers are not sufficient to support a filesystem stored in the system memory. Therefore, in accordance with the present invention, integrated microcontroller 26 addresses the flash memory in non-volatile memory 32 using a DWORD (double word) or 32-bit pointer to provide addressing for memory densities of 64 Kbyte or greater. The DWORD and 32-bit pointer are examples of features that may be present in integrated microcontroller 26 that allow an entire filesystem to be integrated, stored, and operate from non-volatile memory 32. In one embodiment, integrated microcontroller 26 may be an ARM controller, for example, that has native 32-bit instructions and 32-bit internal registers. The DWORD or 32-bit pointer allow pointer math in single instructions and pointer manipulation. It should be noted that 32-bit instructions and 32-bit internal registers are not a limitation of the present invention and instructions and registers having widths greater than 32-bits may be used.

The processing provided by integrated microcontroller 26 allows manipulation, navigation, access and retrieval of data stored to the filesystem that resides in non-volatile memory 32. Typically, the filesystem includes a set of abstract data types, a hierarchical organization that involves a physical location of files, or virtual files that are best manipulated and accessed by integrated microcontroller 26 using instructions and pointers having at least 32-bits.

Integrated microcontroller 26 further supports multiple memory addressing modes, some possible examples include direct addressing, immediate addressing, indirect addressing, relative addressing and register addressing. Integrated microcontroller 26 may also support higher level software instructions such as mathematical instructions, program control instructions, and virtual memory support. Examples of mathematical instructions would be multiply/add/subtract. Examples of program control instructions would be branch/jump/subroutine. The example instructions are provided in integrated microcontroller 26, but other instructions may be incorporated.

The architecture described and incorporated in the present invention supports a logical interface (not to be equated with the physical memory interface 22) between host processor 14 and non-volatile memory 32. The logical interface provided by integrated microcontroller 26 facilitates changes made to the non-volatile memory device without necessitating changes to the filesystem or host processor 14. Whereas, prior art memory controllers support a sectored interface in a flash device, note that integrated microcontroller 26 provides the sectored interface and an additional full filesystem interface. Again, the full filesystem interface provides flexibility in support of changes made to the memory technologies provided in system memory 24.

The filesystem stored to non-volatile memory 32 may be integrated at a sector level or a file level, which allows integrated microcontroller 26 to off-load host processor 14 and provide the processing to execute the filesystem that is resident with non-volatile memory 32. When the filesystem is integrated at the sector level, the filesystem provides a logical read/write Application Programming Interface (API) for logical sectors. The API provides commonly-used functions that may be used advantageously to remove programming tasks. With the filesystem integrated at the sector level there is a logical integration point for a File Allocation Table (FAT). The FAT filesystem may be used to translate a logical sector number to a physical flash device. When the filesystem is integrated at the file level, the filesystem stored in non-volatile memory 32 provides the file level read/write/open/close operations for specific files.

Integrating the integrated microcontroller 26 with the non-volatile memory 32 in accordance with the present invention provides a flash interface that is defined at a logical level. This interface allows different memory devices to be used in system memory 24 without making changes to the filesystem software. With this configuration of the integrated microcontroller 26 integrated with non-volatile memory 32, integrated microcontroller 26 translates the physical interface on the memory side to a static logical interface on the host processor side. The advantage of using the described architecture is that the isolated layer (the host processor 14 side) of the flash filesystem does not have to be swapped based on the specific flash device used in the system.

Embodiments that integrate the filesystem at either the sector level or the file level provide an advantage in the logical interface to the flash device. As flash memory cell features trend to smaller and smaller transistor geometries, the physical flash APIs may be impacted with additional write restrictions that may not be isolated to a single flash software layer. By way of example, flash devices may include Error Correcting Codes (ECC) that have write restrictions that impact every layer of the flash filesystem software. The encoding and decoding routines of ECC may preclude isolation to a single flash software layer, but fit nicely into the present invention that implements integrated microcontroller 26 with non-volatile memory 32 to allow the flash interface to be defined at a logical level. This architecture allows integrated microcontroller 26 to present a static logical interface to the host processor by translating the changing physical interface using the integrated microcontroller.

By completely integrating the flash filesystem into integrated circuit 34 and making integrated microcontroller 26 responsible for exposing the logical interface and defining the flash interface at a logical level, the flash technology may be modified without making changes to the OEM flash filesystem software. The software Flash Abstraction Layer that is implemented by integrated microcontroller 26 abstracts the physical flash interface and hides any technology limitations behind the logical interface.

By now it should be apparent that the present invention enhances host processor execution by transferring the computational load of the filesystem from the host processor to the integrated microcontroller. The physical nature of the non-volatile memory may be changed without the necessity of making changes to the host software. The present integrated microcontroller exposes a static logical interface to the host system which eliminates the burden on the host software to change every time the flash process technology is changed.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A memory device to interface to a host processor, comprising:
an integrated microcontroller; and
a non-volatile memory integrated with the integrated microcontroller to store a filesystem, wherein the integrated microcontroller provides a static logical interface to the host processor.

2. The memory device of claim 1 wherein the filesystem is pre-programmed in the non-volatile memory.

3. The memory device of claim 1 wherein the integrated microcontroller includes a pointer for storing at least 32 address bits to access the non-volatile memory.

4. The memory device of claim 1 wherein the integrated microcontroller includes 32-bit registers.

5. The memory device of claim 1 wherein the non-volatile memory is a flash memory.

6. The memory device of claim 1 wherein the static logical interface to the host processor does not change even when changes are made to the non-volatile memory.

7. A memory system comprising:
a non-volatile memory; and
an integrated microcontroller integrated with the non-volatile memory to operate a filesystem stored in the non-volatile memory, wherein the integrated microcontroller provides a static logical interface to a host processor.

8. The memory system of claim 7 wherein a physical nature of the non-volatile memory can change while the integrated microcontroller absorbs the change to provide the static logical interface to a host processor.

9. The memory system of claim 7 wherein the static logical interface eliminates host software from changing for a new non-volatile memory process.

10. The memory system of claim 7 wherein the integrated microcontroller provides a full filesystem interface and a sectored interface.

11. A wireless device comprising:
first and second antennas;
a host processor having first and second core processors, wherein the first core processor receives a modulated signal from the first and second antennas; and
system memory coupled to the host processor, wherein the system memory includes,
non-volatile memory to store a filesystem, and
an integrated microcontroller integrated with the nonvolatile memory is coupled between the host processor and the non-volatile memory to provide the host processor with a static logical interface.

12. The wireless device of claim 11 further including a Random Access Memory (RAM), wherein the integrated microcontroller is coupled between the host processor and the RAM.

13. The wireless device of claim 11 further including a Read Only Memory (ROM), wherein the integrated microcontroller is coupled between the host processor and the ROM.

14. The wireless device of claim 11 wherein the non-volatile memory is programmed with the filesystem by a manufacturer of the non-volatile memory.

15. The wireless device of claim 11 wherein the integrated microcontroller further includes a Flash Abstraction Layer (FAL) to abstract a physical flash interface to hide flash process changes and provide the static logical interface to the host processor.

16. A method comprising:
abstracting a physical flash interface of a flash memory device to hide flash process changes and provide a static logical interface to a host processor.

17. The method of claim 16 further comprising:
using a Flash Abstraction Layer (FAL) in an integrated microcontroller to provide the abstracting of the physical flash interface.

18. The method of claim 16 further comprising:
storing a filesystem in the flash memory device.

19. The method of claim 18 further comprising:
using the filesystem to provide file level read/write/open/close operations to the flash memory device.

20. The method of claim 16 further comprising:
using an integrated microcontroller having 32-bit registers to couple the flash memory device to the host processor.
